(19) United States
(12) Patent Application Publication
(10) Pub. No.: US 2005/0112345 A1
(43) Pub. Date: May 26, 2005

(54) Translucent paper-plastic-paper laminate

(76) Inventors: Alan Kavasch, Basking Ridge, NJ (US); Jonathan B. Rivlin, East Brunswick, NJ (US)

Correspondence Address: WINSTON & STRAWN;PATENT DEPARTMENT, 1400 L STREET, N.W., WASHINGTON, DC, 20005-3502, US

(21) Appl. No.: 10/723,919

(22) Filed: Nov. 24, 2003

(51) Int. Cl. B32B 7/02

(52) U.S. Cl. 428/216

(57) ABSTRACT

The invention relates to a translucent paper-plastic-paper laminate composed of an oriented polymer film and two paper layers that are laminated to the front and back surfaces of the film. The paper layers are sufficiently thick to receive printing thereon but sufficiently thin not to affect the laminate strength and to allow the laminate to be translucent. The thickness of the polymer film and the weight of each paper layer can be varied depending on the desired final product. The laminate is durable, readily printable, and can be colored, and its thickness and translucency can be altered by changing the weight of the paper layers. These characteristics add versatility to the laminate, making it useful in such products as envelopes and other dilatable container materials, book dust jackets, and other similar packaging materials.

### FIELD OF INVENTION

This invention relates to translucent paper-plastic-paper laminates, which can be used as envelopes and other dilatable container products, dust jackets for books, restaurant menus, and packaging materials. The laminate is made by laminating two paper layers to the front and back of a polymer film, and can be modified to varying degrees of weight, thickness, stiffness, and translucency by altering the weight of the paper layers or the thickness of the polymer film.

### BACKGROUND OF INVENTION

The present invention relates to a translucent paper-plastic-paper laminate for use in applications where a high strength, water and tear resistant material is needed. In particular, the present laminate has utility as an envelope or other dilatable container material, or as a book dust jacket, restaurant menu, or other similar material. The paper layers of the laminate readily accept printing, whereas the plastic film imparts the high strength and moisture resistance to the laminate.

It is known to make envelopes or other dilatable container products from laminates of paper-plastic or paper-plastic-paper, as evidenced by U.S. Pat. Nos. 5,244,702 and 6,652,984. These materials are very desirable for their intended utilities since the plastic film imparts high strength to the laminate while the paper layer(s) enable the laminate to be printed. The three-ply material is further advantageous as it lies flat so that it can be processed by conventional envelope-making equipment used for conventional paper.

It is also known from U.S. Pat. No. 3,669,822 that relatively thin paper layers can be adhered to an embossed plastic film to provide an inexpensive, disposable, fabric-like material.

There is a need, however, for laminate materials whose weight, stiffness, and translucency can be altered, and this need is not addressed satisfactorily by the prior art. The present invention fulfills this need by providing a durable, translucent laminate whose characteristics such as weight, stiffness, and degree of translucency can be easily modified according to the need. The ability to control such characteristics provides a great commercial advantage by adding flexibility to the prior art.

### SUMMARY OF THE INVENTION

The invention relates to a translucent paper-plastic-paper laminate that can used in applications requiring a high strength, water and tear resistant material, such as envelopes or other dilatable container materials, packaging materials, dust jackets for books, or restaurant menus.

The laminate comprises an oriented polymer film and two paper layers that are laminated to the front and back surfaces of the film. Each paper layer is sufficiently thick to readily receive printing but is also sufficiently low in weight not to affect the laminate strength and to allow the laminate to be translucent. The weight of each paper layer can be varied, which allows laminates to be made to different levels of thickness and translucency. In a preferred embodiment, each paper layer has a weight of between about 8 and 15 pounds per 3,000 square feet.

The laminate can be made with a transparent polymer film and paper layers having a sufficiently low weight such that the laminate has high contact clarity and objects in contact with the laminate are readable. In comparison, where the polymer film is transparent and each paper layer has a sufficiently high weight, the laminate's contact clarity may be reduced such that objects in contact with the laminate are visible but cannot be read or precisely discerned. Because of the relatively thin weight of the paper, it is preferred that approximately the same weight be used for each paper layer in order to obtain optimum laminate flatness. Different combinations of paper weights also can be used to provide flat laminates as well, but when the lowest paper weights are used, the laminate should be checked for an acceptable level of flatness.

A number of different features and their combinations can be utilized for both the polymer film and the paper layers, thereby enhancing the versatility of the invention. Preferably, at least one paper layer can be partially printed or the polymer film can be colored to impart the desired aesthetic effects. Depending upon the specific application, the polymer film may have a thickness of between 0.45 and 3 mils.

In another preferred embodiment, the paper layers are laminated to the polymer film by a water-based adhesive using a cold-lamination process, which maximizes film orientation and strength. An advantageous water-based adhesive is an ethylene vinyl acetate copolymer although many others can be used instead.

The flexibility of the invention enables many variations of the product. Products that can be made with the translucent laminate include dust jackets for books, envelopes or other dilatable containers, and packaging materials.

### DETAILED DESCRIPTION OF THE PREFERRED EMBODIMENTS

The present invention relates to a translucent paper-plastic-paper laminate comprising an oriented polymer film and two paper layers laminated to the front and back surfaces of the film.

The term “translucent” is used herein in its ordinary meaning, that is to describe a material that can be penetrated by light so that objects behind the translucent material can be seen. The degree of translucency can range from near transparent, where the object, such as printing, can be seen clearly, to just prior to opaqueness, wherein it is apparent that the object is there but it cannot be read or distinctly perceived.

The polymer film used in the invention is oriented to impart high strength thereto. Usually effected by controlled stretching of the unoriented film, orientation results in molecular orientation. A biaxial orientation, in which orientation is done both in longitudinal and transverse directions, is preferred for greatest strength.

The thickness of the polymer film is selected to provide the desired rigidity or stiffness to the final product. Depending upon the type of polymer used, thickness can vary over a wide range, with thickness of about 0.45 to 3 mils being typical, with a thickness of between 0.48 and 2 being acceptable for most polymers. A preferred polymer film is 0.75-mil polyethylene terephthalate, as this provides a suitable stiffness for a book jacket cover. Preferred thicknesses for PET material range from 0.48 to 1 mil. Different thicknesses can be used for other polymer films as desired for the final use of the laminate.

The paper layers are preferably cold laminated to the plastic film in the manner described in U.S. Pat. Nos. 5,244,702 and 6,652,984, the content of each of which is expressly incorporated herein by reference thereto. As noted in those patents, the paper-plastic-paper laminate is produced by feeding the polymer film and each paper layer into a pair of pressure rolls driven at high speed by a motor. The nip between the pressure rolls is related to the thickness of the webs to be laminated and is adjusted to provide the required degree of laminating pressure to ensure secure bonding of the webs.

The line speed for production of the laminate can vary, depending upon the strength of the paper web. For a relatively thin paper web of low strength, the operating speed must be such as not to rupture the paper web. Typical speeds vary between about 200 to 300 feet per minute for paper weights of around 12 pounds per 3,000 square feet.

The water-based adhesive is applied to the polymer film which contacts the paper prior to entering pressure rolls. The amount of adhesive to be applied to the film is not critical. For the paper weights disclosed herein, a water-based aqueous adhesive that has 4 to 5 pounds of adhesive (at 50% solids) can be used so that 2 to 2.5 pounds of solid adhesive are applied per 3,000 sq. ft. of paper. The adhesive is applied to a roller via a doctor blade and then is transferred from the roll to the film by contact therebetween. The same amount of water-based adhesive can be used regardless of the weights of the paper sheets.

Preferably, an ethylene vinyl acetate copolymer composition, which has an affinity both for the paper and the film, is used as the water-based adhesive. Such water-based adhesive is fluid at ambient temperature. Moreover, a water-based adhesive does not require the use of volatile organic solvents, thus avoiding adverse health and environmental effects associated with such solvents as well as additional costs for recovering or disposing the solvents. Given that paper tends to absorb water, applying a water-based adhesive to the film before it is fed into the pressure rolls limits the time during which the paper can absorb water and adhesive therein. This allows the lamination to be complete as soon as it exits the nip rolls. Also, as no heat needs to be added to the process to complete the lamination, the orientation properties of the polymer film are preserved. For these reasons, the cold lamination process is preferred for forming the lamination, since it allows one to remain under the glass transition point of a specific plastic film. One can apply heat prior to lamination without affecting strength or orientation for varying reasons so long as it does not exceed the glass transition point of the plastic film. After lamination is complete, the laminate is much less sensitive to heat and routine tests can be conducted to determine the maximum allowable temperature to which the laminate can be exposed.

Alternatively, the paper layers may be laminated to the film by the use of any adhesive. One of ordinary skill in the art is well aware of the different types of adhesives and how to use them to join sheets or webs of paper and plastic. The optimum amount of adhesive can be determined for any particular application by routine testing. Due to the time needed to set or cure those other adhesives, production speeds are likely to be lower. Some of these adhesives are not preferred for certain applications. For example, when hot melt adhesives are used, the oriented film will generally lose some orientation and strength because heat acts to relax the film and therefore causes it to lose its molecular orientation. Further, for hot melt or reaction-cure adhesives, care must be taken to assure that the paper layer remains in alignment with the film until cured. Hot melt adhesives also take a longer lamination time because of the additional time required for cooling the adhesive before secure bonding between the film and the papers is achieved. While these issues can be tolerated in certain applications, they are not present when the cold lamination process is used, and it is therefore preferred to join the paper layers to the film using the cold lamination process when higher production rates are desired and film orientation and strength is to be maintained at the highest possible level.

Another advantageous feature of the present invention is that the weight of each paper layer in the laminate can be varied. Specifically, each paper layer has a thickness sufficient to receive printing thereupon but is sufficiently low in weight so as to allow the laminate to be translucent and not to affect the laminate strength. Hence, the weight of the paper layer may be varied according to the desired degree of translucency. A sufficiently low paper weight would provide a high contact clarity and readability such that objects in contact with the laminate are readable and clearly discerned. Likewise, a sufficiently high paper weight would make the laminate closer to opaque, thus allowing objects in contact with the laminate to be visible but not readable.

Each paper layer generally has a weight of between about 8 and 15 pounds, and preferably between about 10 and 13 pounds, per 3,000 square feet. In a preferred arrangement, both paper layers have the same weight. If desired, however, one paper layer may have a different weight from the other depending on the end use of the laminate. The use of the same or different weight paper layers enables a non-curling, flat laminate to be achieved.

An unexpected advantage of the invention is that a translucent laminate is provided compared to the use of the same weight paper by itself For example, a sheet of paper that weighs 24 pounds per 3000 square feet has little or no translucency, whereas two 12 pounds per square foot sheets laminated to a plastic film surprisingly provides translucent laminate with the attendant advantages disclosed herein. This is unexpected because the same total weight of paper is used in the laminate as in the separate sheet.

Because the paper layers of the laminate present printable surfaces, one or both paper layers may be printed. The printing can be arranged to mask or complement information that is viewable through the translucent laminate. Color printing can be used to advantage here. In another embodiment, the paper layers, the polymer film, or both may be colored or printed to provide a different appearance to the laminate.

The flexibility of printing or coloring the laminate of the present invention offers great commercial and personal utility for products made therefrom. The laminate may be made into a translucent envelope that is water and tear resistant. Addresses, logos, advertisements, or such other information may be printed on the envelope, and the translucency of the envelope may be varied to suit the desired purpose. The envelope may be made with a high level of translucency such that letters inside the envelope can be read through to encourage the receiver to open the envelope. Or, for sensitive contents, the envelope can either be made with a laminate with a higher paper weight or with appropriately placed printing or masking text or colors so that the contents of the envelope cannot be read through the laminate.

Similarly, the laminate can be used to make a packaging material, for which the ability to change the thickness and stiffness of the laminate, as well as its water and tear resistant quality, is particularly useful. In this application, the weight of the paper layers and/or the thickness of the film can be adjusted depending on the objects to be packaged.

The laminate may also be used as a dust jacket for a book, i.e., a sleeve that surrounds a book to prevent damage or deterioration of the book cover. When used as such, the present laminate allows printing thereon but still retains its translucency so that the cover remains visible through the jacket. The dust jacket may be printed with, for example, book title and author information, graphics, or personal notes. The printing can be made to coordinate with the designs or printing of the book cover while providing protection of the book at least until purchased. Thereafter, the consumer can remove the jacket or allow it to remain on the book.

Another use for the present laminate is as archivable paper. When printed and stored for long periods of time, the laminate retains its strength and resists yellowing over time because of the adherence of the paper to the film. The strength and durability of the laminate makes it a desirable material for preserving valuable prints.

The laminate may also be used as a restaurant menu. Because it is water and tear resistant and can be made as thin and pliant, or thick and stiff, as desired, the laminate provides an attractive material to be used everyday as a restaurant menu or advertisement.

While above description provides preferred embodiments of a paper-plastic-paper laminate in accordance with the invention, it will be appreciated that the nature of the invention allows many changes and modifications to be made therein without departing from the essential spirit thereof.

1. A translucent paper-plastic-paper laminate comprising an oriented polymer film as a strength member and two paper layers that are laminated to front and back surfaces of the film, wherein each paper layer is present at a thickness that is sufficient to receive printing thereon but is sufficiently low not to contribute to laminate strength and to enable the laminate to be translucent such that objects in contact with the laminate are visible through the laminate, wherein each paper layer has a weight of between about 8 and 15 pounds per 3,000 square feet of paper layer.

2. (Cancelled)

3. The laminate of claim 1 wherein each paper layer has a weight of between about 10 and 13 pounds per 3,000 square feet of paper layer.

4. The laminate of claim 1 wherein the polymer film is transparent and each paper layer has a weight which is sufficiently low so that the laminate provides contact clarity whereby objects in contact with the laminate are readable.

5. The laminate of claim 1 wherein the polymer film is transparent and each paper layer has a weight which is sufficiently high so that objects in contact with the laminate are visible but not readable.

6. The laminate of claim 1 wherein each paper layer has approximately the same weight so that a non-curling flat laminate is obtained.

7. The laminate of claim 1 wherein at least one paper layer is partially printed.

8. The laminate of claim 1 wherein the polymer film is colored or printed.

9. The laminate of claim 1 wherein the polymer film has a thickness of between 0.45 and 3 mils.

10. The laminate of claim 1 wherein the polymer film has a thickness of between 0.48 and 2 mils.

11. The laminate of claim 1 wherein the paper layers are laminated to the film by a water-based adhesive using a cold lamination process so that film orientation and strength are maximized.

12. The laminate of claim 10 wherein the water-based adhesive comprises an ethylene vinyl acetate copolymer.

13. A dust jacket for a book comprising the laminate of claim 1.

14. A translucent envelope comprising the laminate of claim 1.

15. A packaging material comprising the laminate of claim 1.
